(19) United States
(12) Patent Application Publication
(10) Pub. No.: US 2011/0234864 A1
(43) Pub. Date: Sep. 29, 2011

(54) IMAGING DEVICE

(75) Inventor: Kazuyuki INOKUMA, Kyoto (JP)

(73) Assignee: PANASONIC CORPORATION, Osaka (JP)

(21) Appl. No.: 13/154,184

(22) Filed: Jun. 6, 2011

Related U.S. Application Data
(63) Continuation of application No. PCT/JP2009/006555, filed on Dec. 2, 2009.

(30) Foreign Application Priority Data
Feb. 3, 2009 (JP) 2009-022590
Mar. 24, 2009 (JP) 2009-072645

(51) Int. Cl. H04N 9/04

(52) U.S. Cl. 348/280; 348/E09.002

(57) ABSTRACT

A color filter array having two color filter patterns of 2×2 pixels is employed. In one of the two color filter patterns, the transmittances of the R and B filters are lower than the transmittances of the G color filters. In the other color filter pattern, the transmittances of the G color filters are lower than the transmittances of the R and B color filters. As a result, when four adjacent pixels are binned in moving images, three or more different colors are generated, and when all pixels are separately read out in still images, the output of an imager is corrected, whereby outputs equivalent to those of the RGB Bayer filter can be generated.

### CROSS-REFERENCE TO RELATED APPLICATIONS

This is a continuation of PCT International Application PCT/JP2009/006555 filed on Dec. 2, 2009, which claims priority to Japanese Patent Application No. 2009-022590 filed on Feb. 3, 2009, and Japanese Patent Application No. 2009-072645 filed on Mar. 24, 2009. The disclosures of these applications including the specifications, the drawings, and the claims are hereby incorporated by reference in their entirety.

### BACKGROUND

The present disclosure relates to imaging devices for use in digital still cameras (DSCs), camcorders, mobile telephones, etc., and more particularly, to imaging devices for handling both still images and moving images.

In recent years, imaging apparatuses which handle both still images and moving images have been increasingly used, including DSCs, camcorders, mobile telephones, etc. Different numbers of pixels are required for still images and moving images. Therefore, in the imaging apparatuses, when moving images are handled, the pixels of the imager is thinned, binned, etc. to reduce the number of pixels, and at the same time, provide a high frame rate required for moving images.

Japanese Patent Publication No. 2004-312140 describes a technique of binning pixels having the same color to reduce the number of pixels by a factor of nine, for example. Because pixels having the same color are binned, pixels need to be binned at intervals (interval pixel binning). The electrodes of a CCD imager are configured so that an odd number of pixels in the horizontal direction×an odd number of pixels in the vertical direction are simultaneously binned, thereby ensuring the uniformity of mass centers after the binning.

When pixels having the same color are binned, binned pixels have the same color as before the binning. However, because only pixels of the same color filter are binned, the pattern of color filters imposes constraints on the binning, i.e., it is difficult to perform flexible binning.

Japanese Patent Publication No. 2003-116061 describes a technique of binning pixels having different colors. In this technique, color filters in a CCD imager are configured so that color images can be obtained despite the different color pixel binning. In particular, in the case of the conventional RGB Bayer array of color filters, the array has a repeating pattern of 2×2 pixels. Therefore, if four adjacent pixels are binned, only one color is obtained. Japanese Patent Publication No. 2003-116061 describes a technique of repeating color filter pattern of 3×1 pixels or 3×2 pixels to obtain different colors.

Japanese Patent Publication No. 2002-112110 describes a technique of increasing the dynamic range when still images are captured. In this technique, dimming filters which reduce incident light from a lens by a factor of n, where n is an integer of two or more, are arranged in a square grid and are attached to the imager on a pixel-by-pixel basis. Of image data output from the imager, data of pixels covered with the dimming filters is multiplied by n, and the resultant pixels are each averaged with surrounding pixels.

### SUMMARY

If the color filter array is changed, the image processing technique corresponding to conventional color filters can no longer be used for still images before binning as well as after binning. Conventionally, in most DSCs, the RGB Bayer array of color filters is used, and the corresponding image processing is performed to obtain a luminance (Y) signal and a color difference (C) signal, and these signals are compressed by the JPEG technique to obtain an image to be recorded.

The RGB Bayer scheme is the oldest technique of producing color images for single-sensor cameras. The accumulated techniques for enhancing image quality in the RGB Bayer scheme are large technological resources, and therefore, if these techniques are abandoned, it is a considerable loss. In particular, because high image quality is required for still images, it is desirable to use the RGB Bayer scheme for images before binning.

On the other hand, there is the following inherent drawback to the different color pixel binning: color is diluted, i.e., so-called color modulation is lowered. Specifically, each color signal obtained from a signal after binning is reduced. Therefore, color signals need to be amplified by image processing. The amplification amplifies noise as well as the signal, disadvantageously leading to a degradation in color S/N. In order to improve the color S/N, techniques of reducing noise have been previously proposed. Therefore, the present disclosure is not directed to the color S/N problem. However, the reduction of color modulation also leads to an increase in false color. In other words, in single-sensor color cameras, signals of pixels are used on which different color filters located at different spatial positions are provided. Therefore, a light and dark pattern of an object is falsely decided to be a color, so that a color which does not originally exist is disadvantageously generated. The color signal amplification also disadvantageously amplifies the false signal.

The present disclosure describes implementations of a novel color filter pattern having a feature that, by adding a simple correction process, color images can be obtained when the different color pixel binning is performed, while the conventional RGB Bayer process can be used when all pixels are separately read out, and a method for processing the color filter pattern.

The present disclosure also describes implementations of a technique of enlarging the dynamic range.

The present disclosure also describes implementations of an imager which can provide both moving images and still images, and can reduce or prevent a false signal generated due to a reduction in color modulation, which imposes a serious problem when the different color pixel binning is performed.

A first example imaging device according to the present disclosure includes an imager configured to convert an optical signal from an object into an electrical signal, the imager including a plurality of photoelectric converters arranged in a horizontal direction and a vertical direction, each photoelectric converter serving as a pixel, a binning section configured to bin charge of four pixels adjacent to each other in the horizontal and vertical directions of the imager, and a controller configured to select and control a first operation mode in which signals of all the pixels are separately output without performing the four-pixel binning, and a second operation mode in which signals obtained by the four-pixel binning are output. The imager includes a color filter array which provides three or more separate chrominance signals in each of the first and second modes. The imaging device further includes a corrector configured to correct the output of the imager so that an RGB Bayer process can be performed in the first operation mode.

Specifically, the color filter array is an RGB Bayer array whose transmittance is modulated in a predetermined pattern.

The corrector changes the gain of each pixel to cancel the predetermined transmittance modulation pattern of the RGB Bayer array. Therefore, the normal RGB Bayer process can be performed using such a simple method.

The dynamic range can be enlarged by, when a pixel having a high transmittance is saturated on the color filter array, performing interpolation using only an unsaturated pixel or pixels before performing the RGB Bayer process.

When the four-pixel binning is performed, a combination of two pixels to be binned in the horizontal direction is changed on a post-binning row-by-row basis in units of two rows in which binning is performed in the vertical direction, thereby obtaining separate color signals having three or more colors. Therefore, color images can be obtained even in the four-adjacent pixel binning.

A second example imaging device according to the present disclosure includes an imager configured to convert an optical signal from an object into an electrical signal, the imager including a plurality of photoelectric converters arranged in a horizontal direction and a vertical direction, each photoelectric converter serving as a pixel, and a color filter configured to pass a specific color being provided for each photoelectric converter to obtain a color image, a pixel binning section configured to bin charge of the plurality of pixels and output the binned charge, and a binning combination changer configured to change a combination of pixels to be binned. By changing the binning combination, the sign of a difference value between horizontally, vertically, or diagonally adjacent signals after the binning is inverted at the same position.

Specifically, the binning combination changer changes the binning combination on a frame-by-frame basis. The imaging device further includes a chrominance signal calculator configured to calculate a difference between horizontally, vertically, or diagonally adjacent signals after the binning to obtain a chrominance signal, a chrominance signal frame memory configured to store one frame of outputs of the chrominance signal calculator, and an inter-frame chrominance signal subtractor configured to subtract one of a chrominance signal of a current input frame and a chrominance signal of a previously stored frame from the other.

In the first example imaging device of the present disclosure, there are the four-adjacent pixel binning mode and the all-pixel separate read mode. Therefore, high-definition still images can be generated using all pixels, and moving images can be obtained by increasing the frame rate by the four-adjacent pixel binning. When still images are generated, the color filter pattern can be changed to one which is equivalent to the conventional RGB Bayer array by performing a simple correction process, and therefore, conventional image-quality enhancing techniques can be used without modification, thereby easily obtaining still images having the same image quality as that of the conventional art. In addition, the dynamic range can be enlarged, whereby still images having higher image quality than that of the conventional art can be obtained. When moving images are generated, four adjacent pixels are binned, whereby the binning section of the imager can have a simple configuration. In addition, the range of pixel binning is narrower than when pixels of the same color are binned, whereby moving images having an excellent frequency characteristic, and a higher resolution than that of the conventional art, can be obtained.

The second example imaging device of the present disclosure includes the color signal calculator which changes the combination of pixels to be binned on a frame-by-frame basis, and inverts the sign of the difference value between horizontally, vertically, or diagonally adjacent signals after the binning at the same position, to generate the difference value as a chrominance signal, the color signal frame memory which stores one frame of chrominance signals, and the inter-frame color signal subtractor which subtracts a chrominance signal of a current frame from a chrominance signal of the previously stored frame. Therefore, the chrominance signals are inverted relative to each other at the same position. By subtracting one of the color signals from the other, the chrominance signal is amplified by a factor of two, and at the same time, the influence of a light and dark pattern of an object which is highly temporally correlated is canceled, whereby a false color caused by the light and dark pattern of the object can be effectively reduced or prevented. In particular, this imaging device is considerably useful for different color pixel binning, which lowers color modulation.

### BRIEF DESCRIPTION OF THE DRAWINGS

FIG. 1 is a block diagram showing an entire configuration of an imaging device according to an embodiment of the present disclosure.

FIG. 2 is a diagram showing a color filter array in an imager of FIG. 1.

FIG. 3 is a diagram showing a configuration for a still image process performed by a digital signal processor of FIG. 1.

FIG. 4 is a diagram for describing operation of a gain corrector of FIG. 3.

FIG. 5 is a diagram for roughly describing enlargement of a dynamic range by the configuration of FIG. 2.

FIG. 6 is a diagram for describing in detail the enlargement of a dynamic range by the configuration of FIG. 2.

FIG. 7 is a diagram for describing operation of a high luminance interpolator of FIG. 3.

FIG. 8 is a diagram for describing a color signal extraction process when moving images are captured in the imaging device of FIG. 1.

FIG. 9 is a diagram for comparing frequency characteristics of adjacent pixel binning and interval pixel binning.

FIG. 10 is a diagram showing another color filter array of the imager of FIG. 1.

FIG. 11 is a diagram for describing a color signal generation method when moving images are captured in the imaging device of FIG. 1.

FIG. 12 is a diagram in which a combination of pixels to be binned which is different from that of FIG. 11 is used.

FIG. 13 is a diagram showing an example chrominance signal when there is a light and dark pattern of an object.

FIG. 14 is a diagram in which a combination of pixels to be binned which is different from that of FIG. 13 is used.

FIG. 15 is a diagram showing a detailed configuration of a main portion of FIG. 1.

### DETAILED DESCRIPTION

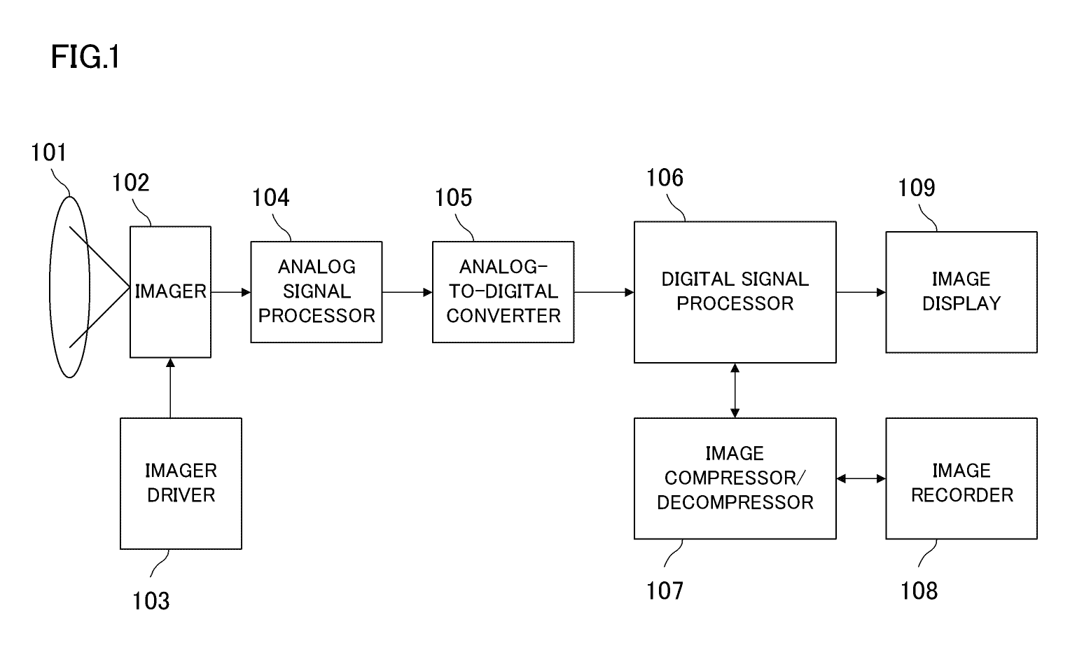

FIG. 1 shows an entire configuration of a digital still camera (DSC) which is an imaging device according to an embodiment of the present disclosure. The DSC includes a lens 101 of an optical system, an imager 102 (e.g., a CCD etc.), an imager driver 103, an analog signal processor 104, an analog-to-digital converter 105, a digital signal processor 106, an image compressor/decompressor 107, an image recorder 108, and an image display 109.

In FIG. 1, an image of an object entering the DSC passes through the lens 101 and is imaged on the imager 102. The imager 102 is driven by the imager driver 103 to perform photoelectric conversion to output an imaging signal. Next, the analog signal processor 104 performs processes, such as noise removal, amplification, etc, on the imaging signal. The analog-to-digital converter 105 converts the resultant imaging signal into a digital signal. The digital signal processor 106 receives the digital imaging signal to generate an image signal including a luminance signal (Y) and a chrominance signal (C). The image display 109 receives the image signal to display an image. While the image displaying is performed, the image compressor/decompressor 107 compresses the image signal received from the digital signal processor 106, and the compressed image data is recorded into the image recorder 108. The image data recorded in the image recorder 108 may be decompressed by the image compressor/decompressor 107, and the resultant data may be processed by the digital signal processor 106 and displayed as an image by the image display 109.

Operations in a still image capture mode and a moving image capture mode of the DSC of FIG. 1 will be described hereinafter.

<Still Image Capture Mode>

The still image capture mode is an “all pixel read” mode in which signals of all pixels of the imager 102 are separately output. The signals of the imager 102 are read out by the imager driver 103 using a known technique, which will not be described in detail.

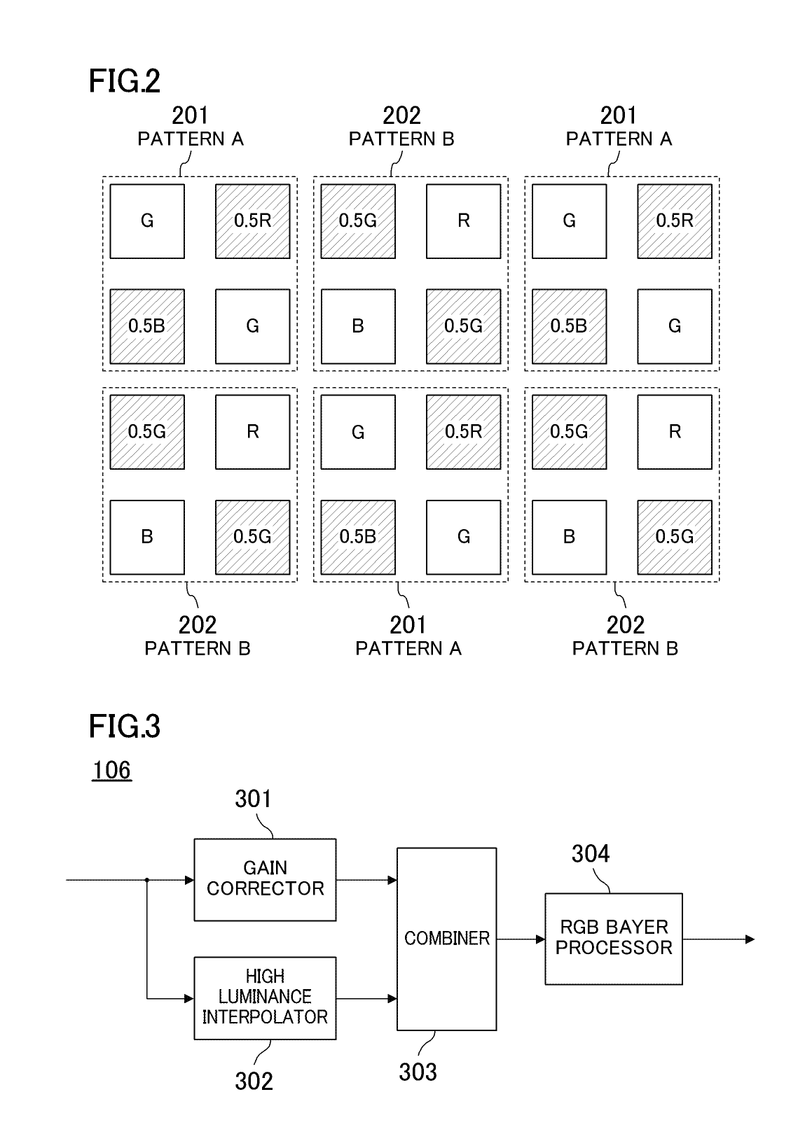

FIG. 2 shows a color filter array of the imager 102 of the present disclosure. The color filter array is composed of basic arrays of 4×2 pixels. Each basic array is composed of two patterns A and B of 2×2 pixels. The two patterns basically have the RGB Bayer arrangement, but different transmittances. In the patterns A indicated by a reference character 201, G pixels have a normal transmittance, and an R pixel and a B pixel have half the normal transmittance. In the patterns B indicated by a reference character 202, an R pixel and a B pixel have the normal transmittance, and G pixels have half the normal transmittance. In addition, in one set of two successive rows, filters are arranged in the order of the pattern A, the pattern B, the pattern A, and so on, and in the next set of two successive rows, filters are shifted by two pixels in the horizontal direction, i.e., arranged in the order of the pattern B, the pattern A, the pattern B, and so on.

A signal output from the imager 102 is input via the analog signal processor 104 and the analog-to-digital converter 105 to the digital signal processor 106.

FIG. 3 shows an example configuration for a still image process performed by the digital signal processor 106. The digital signal processor 106 includes a conventional RGB Bayer processor 304, and in addition, a gain corrector 301, a high luminance interpolator 302, and a combiner 303.

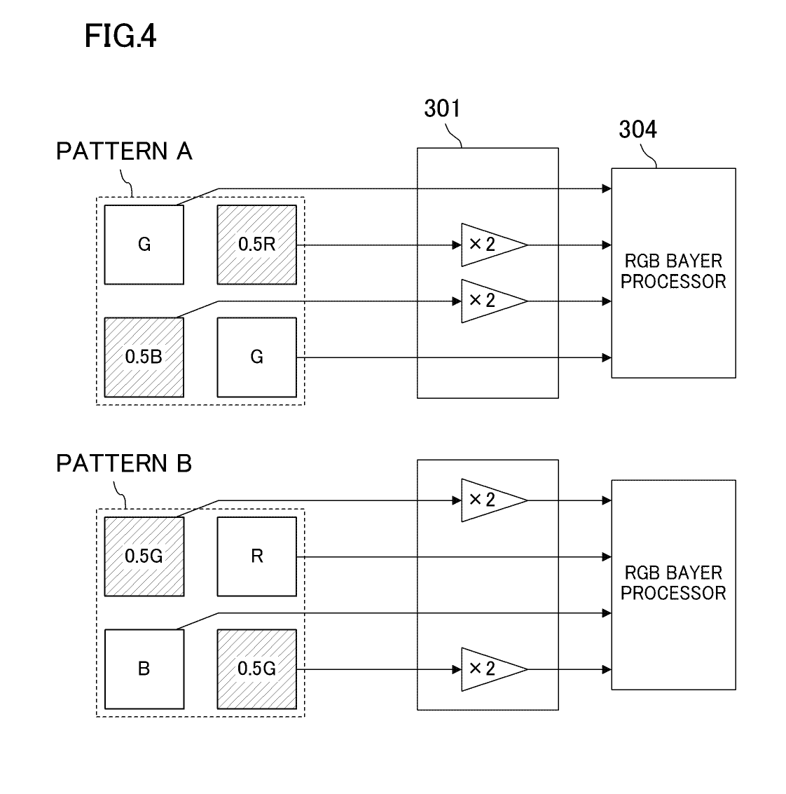

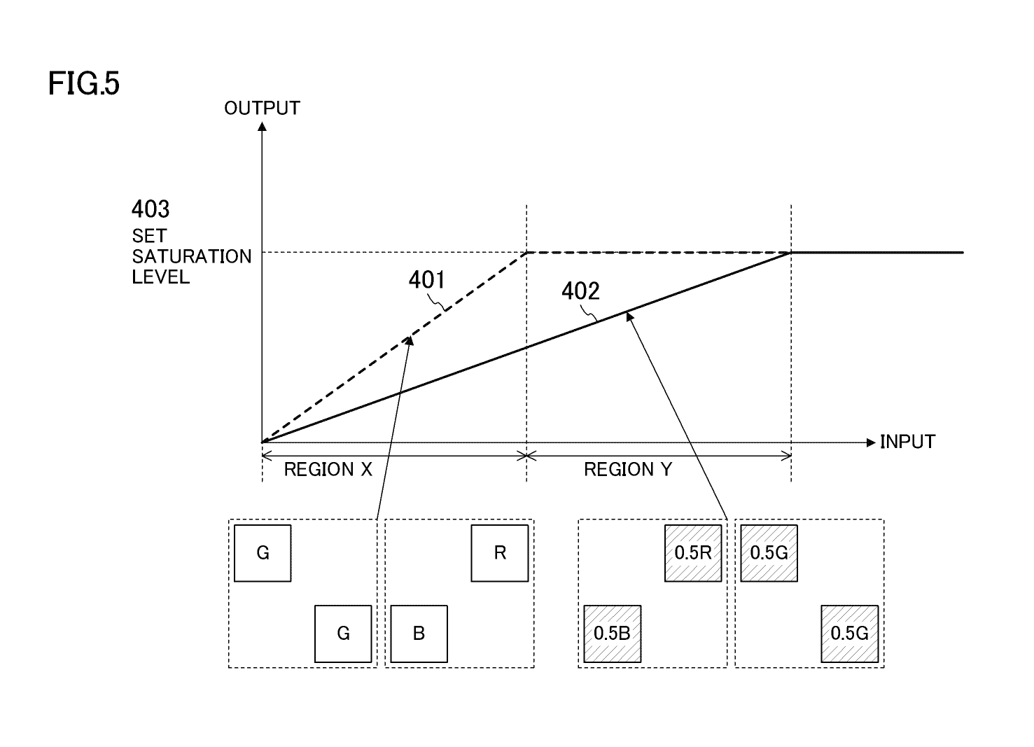

FIG. 4 shows a process performed by the gain corrector 301. For the pattern A, the R and B pixels are amplified by a factor of two, and for the pattern B, the G pixels are amplified by a factor of two. As a result, the signal levels of the pixels in each pattern are equivalent to those of the normal RGB Bayer array, and therefore, the conventional RGB Bayer processor 304 can be used.

FIG. 5 shows a mechanism (additional function) for enlarging the dynamic range. The horizontal axis indicates exposure amounts input to the imager 102, and the vertical axis indicates outputs of the imager 102. The relationship between inputs and outputs of the color filter having the normal transmittance is indicated by a line 401. Specifically, while the output increases in proportion to the input exposure amount in a low luminance region X, the output is constant and is equal to a set saturation level 403 in a high luminance region Y. The relationship between inputs and outputs of the color filter having half the normal transmittance is indicated by a line 402. The line 402 has half the slope of the line 401, and monotonically increases in both the regions X and Y. In other words, while, in the normal RGB Bayer array, only the exposure region X can be reproduced because of the set saturation level 403, both the exposure regions X and Y can be reproduced in the present disclosure, so that the dynamic range is doubled.

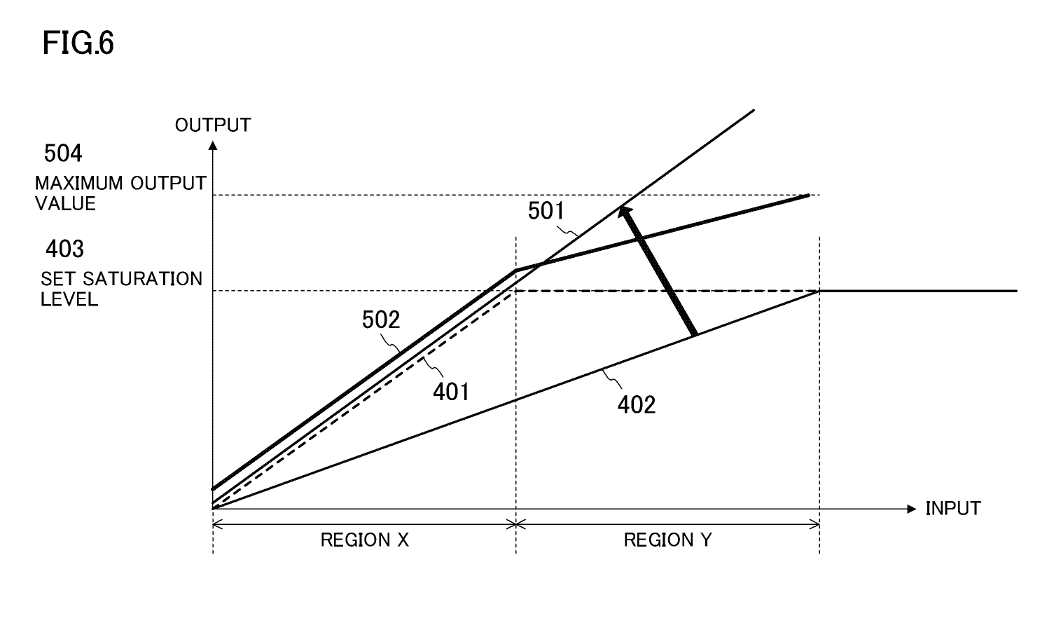

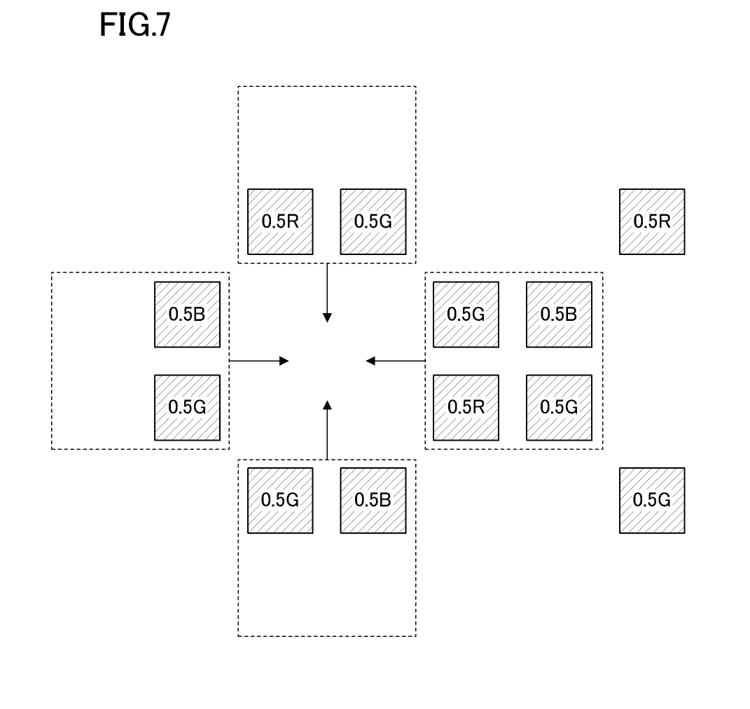

FIG. 6 shows a specific process. The output of the color filter having half the normal transmittance (line 402) is amplified by a factor of two by the gain corrector 301 to be changed to a line 501. In the region X, the outputs of both the color filter having the normal transmittance and the color filter having half the normal transmittance are used to perform a normal Bayer process to generate an image. In the region Y, the color filter having the normal transmittance is saturated and cannot be used, and therefore, only the output of the color filter having half the normal transmittance is used to generate an image. Therefore, an interpolation process is required which is performed by the high luminance interpolator 302 of FIG. 3. As shown in FIG. 7, the interpolation process is performed in units of the 2×2 pixel pattern to generate signals of all pixels. Typically, the high luminance portion is compressed by a so-called knee process with emphasis on gray levels, so that the slope of the line indicating the input-to-output relationship is decreased. As a result, a line 502 is obtained for the entire region. Thus, a maximum output value 504 higher than the set saturation level 403 can be achieved. The combiner 303 combines images in each of the regions X and Y and outputs the result.

<Moving Image Capture Mode>

In the moving image capture mode, four adjacent pixels are binned before being read out. A key feature of the present disclosure is that by combining the color filter array and pixel binning, three or more different colors can be obtained even when four adjacent pixels are binned.

In the imager 102 and the imager driver 103, four adjacent pixels are binned by a known technique (particularly, a technique described in Japanese Patent Publication No. 2003-116061 in the case of a CCD imager), which will not be described.

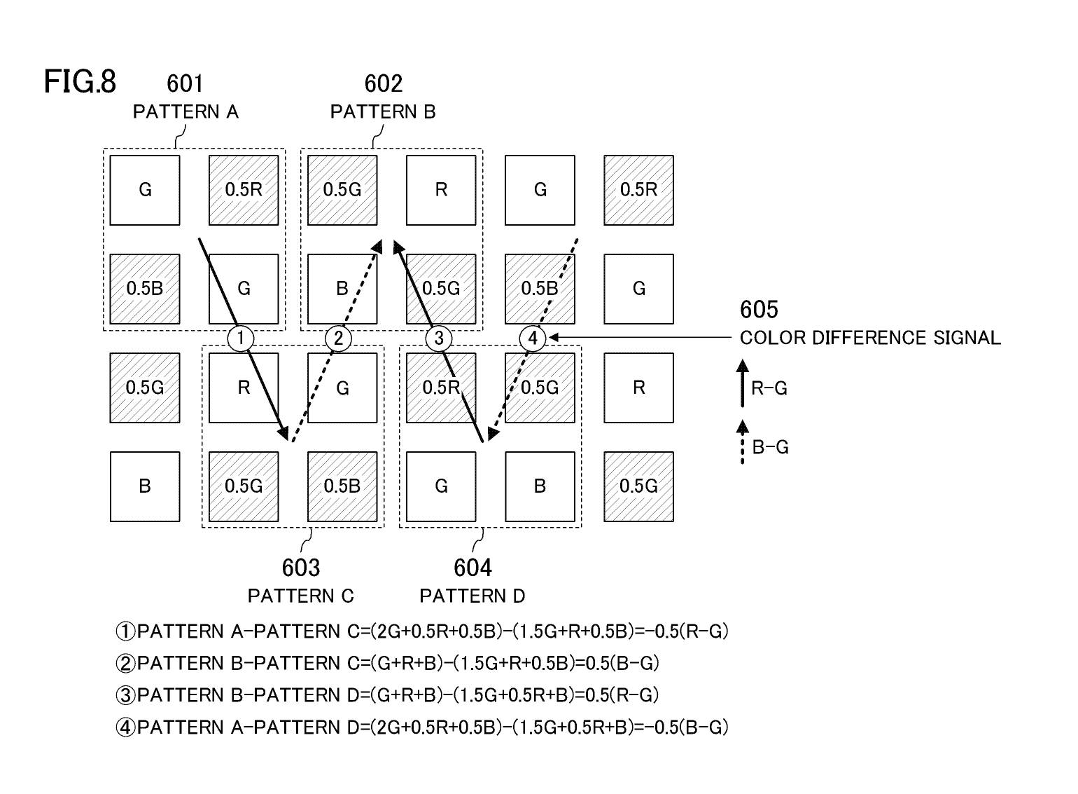

FIG. 8 shows a method for generating a chrominance signal according to the present disclosure, where four adjacent pixels are binned. A mode in which pixel binning is performed in a pattern A (601) and a pattern B (602), and another mode in which pixel binning is performed in a pattern C (603) and a pattern D (604) which are shifted from the pattern A and B, respectively, by one pixel in the horizontal direction, are switched on a post-binning row-by-row basis. Differences between vertically adjacent rows, i.e., between the patterns A and B and the patterns C and D, are calculated.

Specifically, four color difference signals 605 are successively obtained as shown in FIG. 8 as follows.

(1) Pattern A−Pattern C=(2G+0.5R+0.5B)−(1.5G+R+0.5B)=−0.5(R−G)

(2) Pattern B−Pattern C=(G+R+B)−(1.5G+R+0.5B)=0.5(B−G)

(3) Pattern B−Pattern D=(G+R+B)−(1.5G+0.5R+B)=0.5(R−G)

(4) Pattern A−Pattern D=(2G+0.5R+0.5B)−(1.5G+0.5R+B)=−0.5(B−G)

R-based and B-based color difference signals are alternately obtained on an individual pixel basis, and are alternately inverted on a group of two pixels basis. As a result, color images can also be obtained in the moving image capture mode in which four adjacent pixels are binned.

Note that, in FIG. 8, the generation of color difference signals are schematically shown using arrows. A color difference signal is generated by calculation from binned pixels linked by an arrow, and the binned pixel indicated by the arrowhead is a positive element.

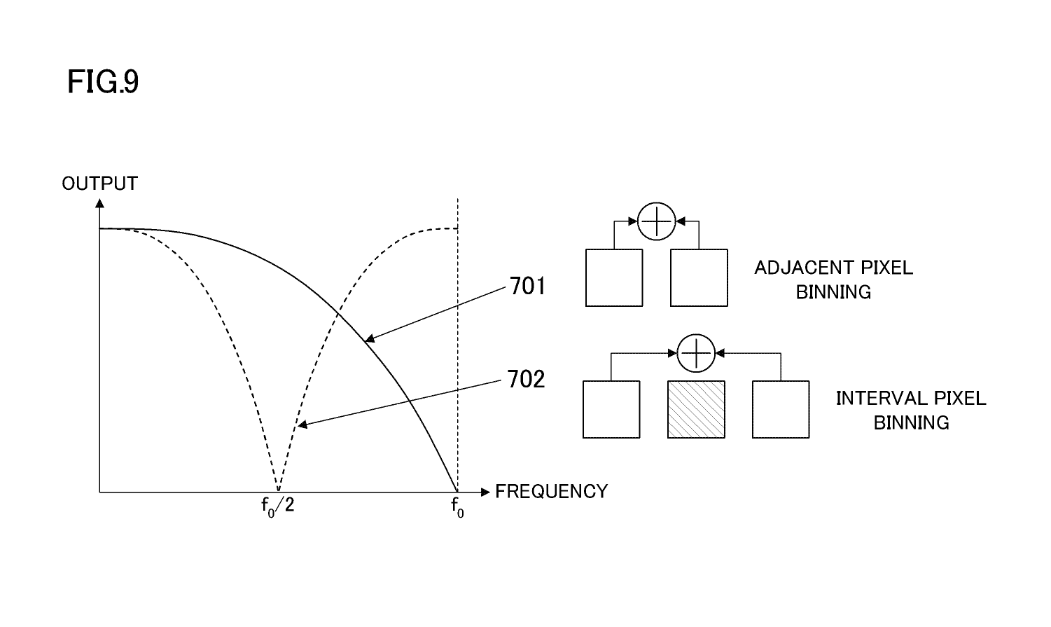

As shown in FIG. 9, adjacent pixel binning can provide a better frequency characteristic than that of interval pixel binning, and can achieve a high resolution even in the moving image capture mode. When adjacent pixels are binned, a low-pass filter (line 701) is obtained, where the zero point is the Nyquist frequency (f₀). When pixel binning is performed on an every other pixel basis, a low-pass filter (line 702) is obtained, where the zero point is half the Nyquist frequency (f₀/2). Therefore, higher-frequency signals are lost in the vicinity of half the Nyquist frequency (f₀/2).

Note that, in this embodiment, as a specific example technique of modulating transmittance, pixels having half the normal transmittance are arranged in a predetermined pattern. The present disclosure is not limited to half the normal transmittance or the arrangement pattern described in this embodiment. Various changes and modifications may be made without departing the spirit and scope of the present disclosure.

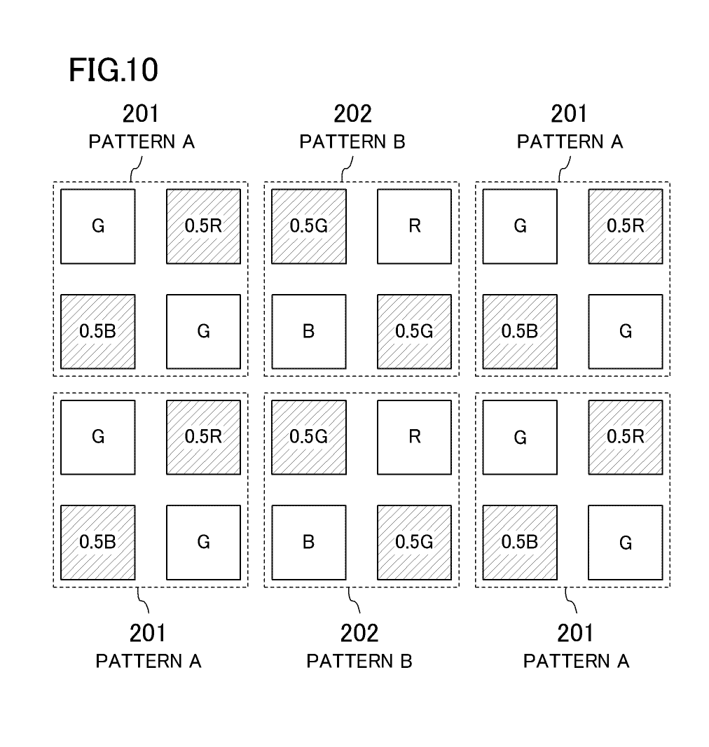

FIG. 10 shows another color filter array of the imager 102. As in the example of FIG. 2, the color filter array is composed of basic arrays of 4×2 pixels, and each basic array is composed of two patterns A and B of 2×2 pixels in FIG. 10. In the patterns A indicated by a reference character 201, G pixels have a normal transmittance, and an R pixel and a B pixel have half the normal transmittance. In the patterns B indicated by a reference character 202, an R pixel and a B pixel have the normal transmittance, and G pixels have half the normal transmittance. Note that, as is different from the example of FIG. 2, any two sets of two rows are not shifted from each other in the horizontal direction, i.e., filters are invariably arranged in the order of the pattern A, the pattern B, the pattern A, and so on.

Even when the color filter array of FIG. 10 is employed, in the still image capture mode in which all pixels are separately read out, an image process corresponding to the RGB Bayer array which is similar to those of the conventional art can be applied by adding a gain correction process for canceling fluctuations of the transmittance.

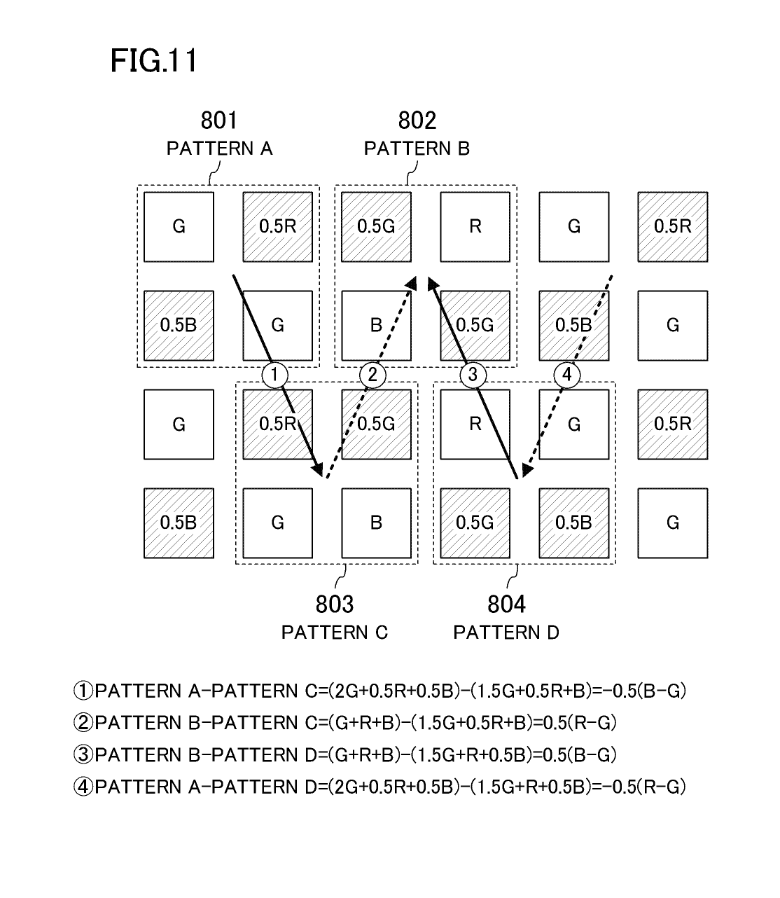

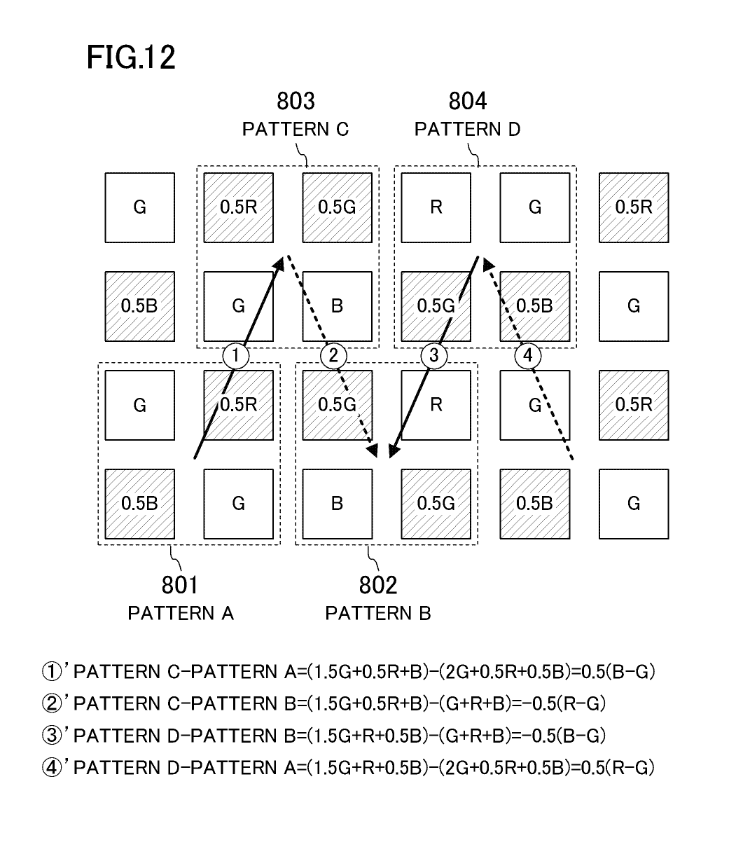

FIG. 11 schematically shows a chrominance signal generation method in the moving image capture mode in which four adjacent pixels are binned in the color filter array of FIG. 10, indicating how chrominance signals are generated on color filters. When four adjacent pixels are binned, there are four filter combinations, i.e., patterns A-D. Therefore, four signals having different RGB values are obtained. As shown in FIG. 11, binning is performed in the patterns A (801) and the patterns B (802) in some lines, while binning is performed in the patterns C (803) and the patterns D (804) which are shifted from the patterns A and B by one pixel in the horizontal direction, in the other lines. The two pattern arrangements are alternately provided on a post-binning row-by-row basis. A signal arrangement after pixel binning is a so-called offset sampling pattern, which can improve a horizontal resolution.

Chrominance signals are generated by calculating differences between vertically adjacent rows, i.e., R−G and B−G signals are obtained. These signals correspond to so-called color difference signals. By calculating differences in diagonal directions as shown in FIG. 11, four color difference signals are successively obtained as follows.

(1) Pattern A−Pattern C=(2G+0.5R+0.5B)−(1.5G+0.5R+B)=−0.5(B−G)

(2) Pattern B−Pattern C=(G+R+B)−(1.5G+0.5R+B)=0.5(R−G)

(3) Pattern B−Pattern D=(G+R+B)−(1.5G+R+0.5B)=0.5(B−G)

(4) Pattern A−Pattern D=(2G+0.5R+0.5B)−(1.5G+R+0.5B)=−0.5(R−G)

Here, R-based and B-based color difference signals are alternately obtained on an individual pixel basis, and are alternately inverted on a group of two pixels basis. As a result, color images can also be obtained in the moving image capture mode in which four adjacent pixels are binned.

Note that, in FIG. 11, the generation of color difference signals are schematically shown using arrows. A color difference signal is generated by calculation from binned pixels linked by an arrow. Four pixels indicated by the arrowhead are a positive element of the resultant signal.

In the next frame, the combination of pixels to be binned is changed as shown in FIG. 12. Specifically, the patterns A and B are shifted by one pixel in the horizontal direction to provide the patterns C and D. Similarly, the patterns C and D are shifted by one pixel in the horizontal direction to provide the patterns A and B. As a result, the rows of the patterns A and B and the rows of the patterns C and D are vertically switched. In this state, differences between vertically adjacent rows are calculated as in the case of FIG. 11, to successively obtain the following color difference signals.

(1)′ Pattern C−Pattern A=(1.5G+0.5R+B)−(2G+0.5R+0.5B)=0.5(B−G)

(2)′ Pattern C−Pattern B=(1.5G+0.5R+B)−(G+R+B)=−0.5(R−G)

(3)′ Pattern D−Pattern B=(1.5G+R+0.5B)−(G+R+B)=−0.5(B−G)

(4)′ Pattern D−Pattern A=(1.5G+R+0.5B)−(2G+0.5R+0.5B)=0.5(R−G)

In other words, compared to the previous frame, the sign of a chrominance signal at the same position is inverted.

If the chrominance signals of FIG. 12 are subtracted from the chrominance signals of the previous frame of FIG. 11, the following chrominance signals are successively obtained.

(1)−(1)′=B−G

(2)−(2)′=−(R−G)

(3)−(3)′=−(B−G)

(4)−(4)′=R−G

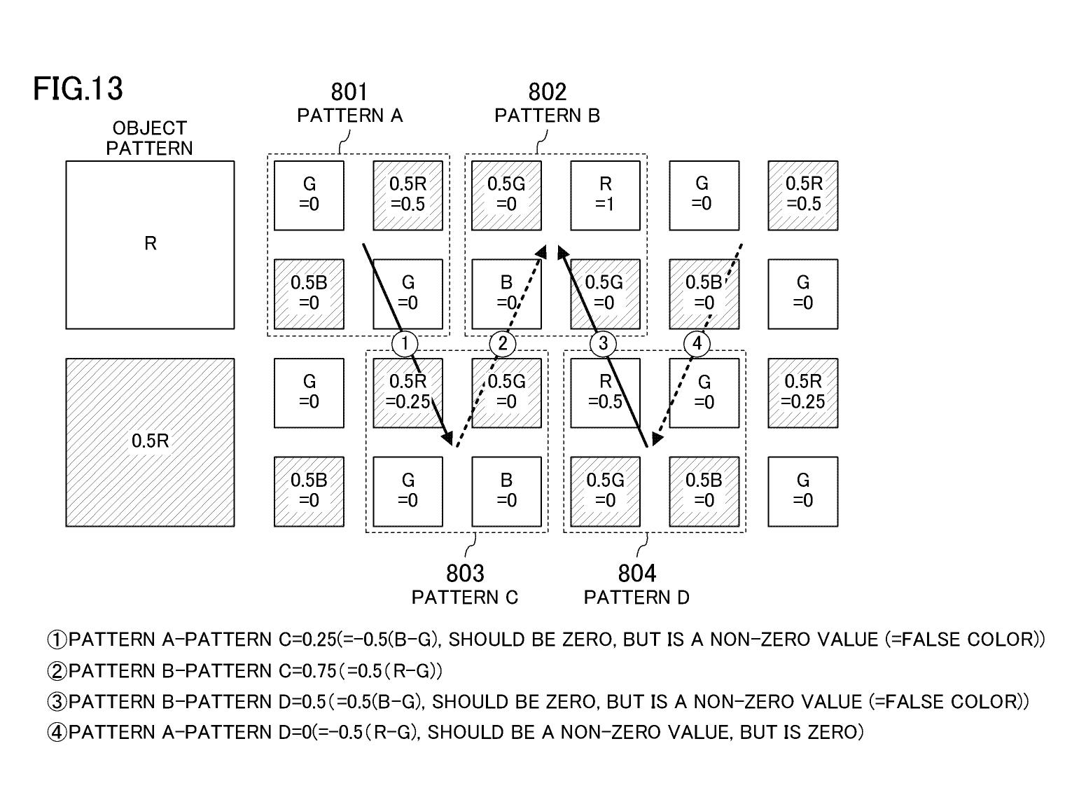

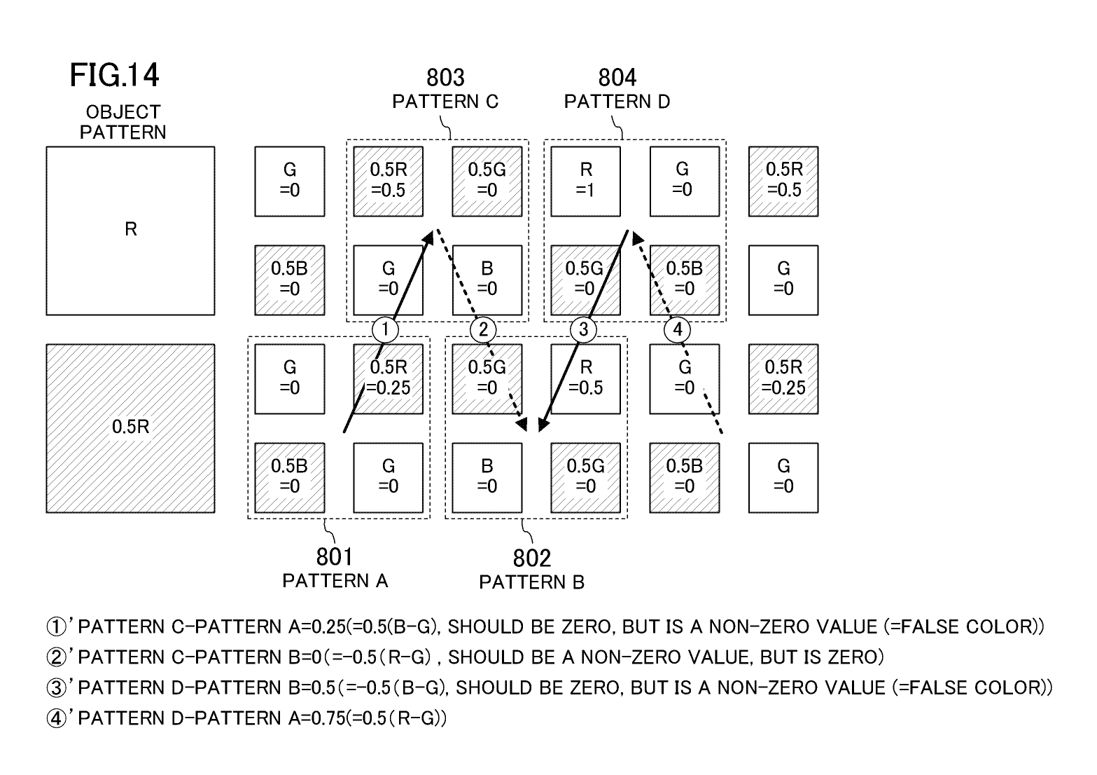

In other words, the chrominance signals are amplified by a factor of two. The influence of a difference in luminance in the vertical direction of an object is canceled. This situation is shown by specific examples of FIGS. 13 and 14.

FIGS. 13 and 14 show a case where a red object from which only R signals are obtained is assumed and there is a difference in luminance in the vertical direction of the object. Specifically, it is assumed that an object pattern has an upper line of R and a lower line of 0.5R. In this case, if a binning combination similar to that of FIG. 11 is performed, the following color difference signals are successively obtained as shown in FIG. 13.

(1) Pattern A−Pattern C=0.25 (=−0.5(B−G))

(2) Pattern B−Pattern C=0.75 (=0.5(R−G))

(3) Pattern B−Pattern D=0.5 (=0.5(B−G))

(4) Pattern A−Pattern D=0 (=−0.5(R−G))

Because there are originally no B and G components, the results of (1) and (3) should be zero, but are non-zero values. These values correspond to false colors.

Next, if a binning combination similar to that of FIG. 12 is performed, the following color difference signals are successively obtained as shown in FIG. 14.

(1)′ Pattern C−Pattern A=0.25 (=0.5(B−G))

(2)′ Pattern C−Pattern B=0 (=−0.5(R−G))

(3)′ Pattern D−Pattern B=0.5 (=−0.5(B−G))

(4)′ Pattern D−Pattern A=0.75 (=0.5(R−G))

Differences between the results of FIGS. 13 and 14 are calculated as follows.

(1)−(1)′=0 (=B−G)

(2)−(2)′=−0.75 (=−(R−G))

(3)−(3)′=0 (=−(B−G))

(4)−(4)′=0.75 (=R−G)

In other words, the B−G components, which are a false color, is zero, and only the correct R−G components are obtained.

Note that, in this embodiment, chrominance signals are obtained from vertical differences, and therefore, chrominance signals are inverted by changing binning combinations in the vertical direction, thereby canceling the influence of the difference in luminance in the vertical direction of an object. Strictly speaking, chrominance signals are obtained from diagonal differences between pixels which are also shifted from each other by one pixel in the horizontal direction, and therefore, there is the influence of the difference in luminance corresponding to one pixel in the horizontal direction. While the signs of pixel components are inverted in the vertical direction as indicated by arrows in FIGS. 11 and 12, there is no inversion in the horizontal direction. In other words, there is the influence of the difference in luminance corresponding to one pixel in the horizontal direction.

Note that there is also the influence of a difference in luminance corresponding to one pixel in the horizontal direction in the still image capture mode in which all pixels are separately read out, and therefore, the horizontal luminance difference is typically reduced or prevented by an optical low-pass filter. In other words, when pixel binning is performed, a separation between binned pixels is primarily responsible for the generation of a false color. Here, although the separation in the vertical direction between binned pixels to be calculated is two pixels, and therefore, a false color could be generated due to a reduced effect of the optical low-pass filter, but is effectively removed in this embodiment. In contrast to this, because the separation in the horizontal direction between binned pixels to be calculated is only one pixel, a false color is inherently small, and therefore, no significant problem arises in this embodiment which does not take measures against the horizontal false color.

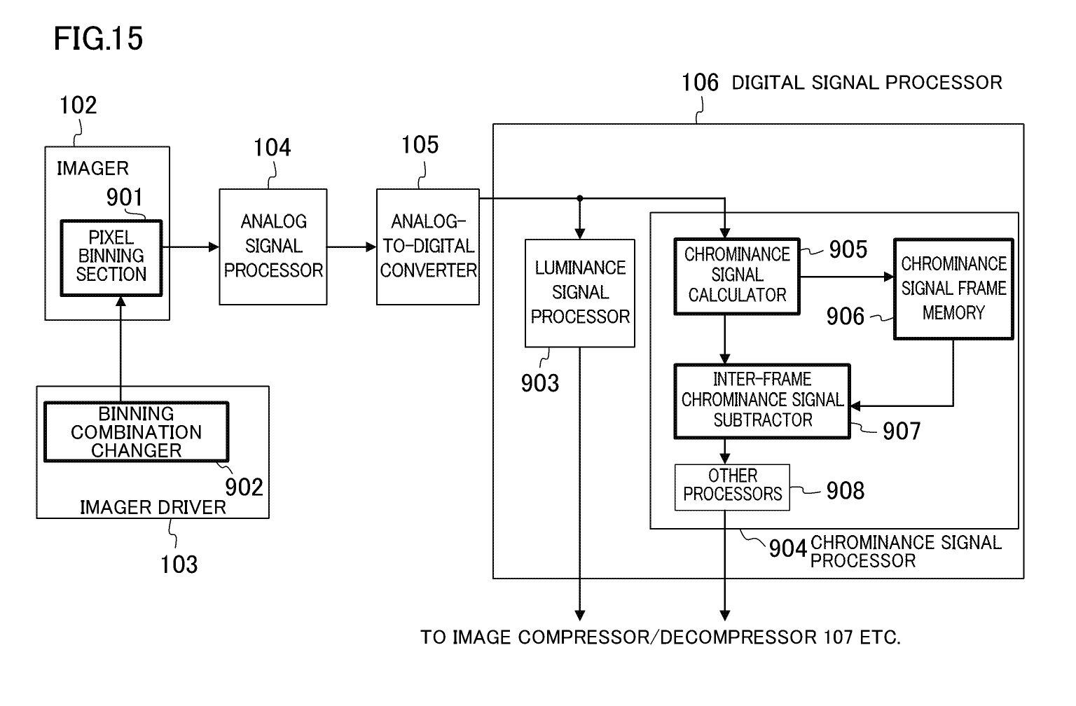

FIG. 15 is a diagram showing a configuration of an imaging device which performs the aforementioned process of binning different color pixels. The same parts as those of the entire configuration of the DSC of FIG. 1 are indicated by the same reference characters. In the imager 102, a pixel binning section 901 which bins adjacent pixels is provided. In the imager driver 103, a binning combination changer 902 which changes a combination of pixels to be binned is provided. The binning combination changer 902 changes a binning combination on a frame-by-frame basis as shown in FIGS. 11 and 12. Actual pixel binning is performed in the pixel binning section 901 of the imager 102. The sign of a difference between signals of diagonally adjacent pixels output from the imager 102 is inverted at the same position on a frame-by-frame basis as shown in FIGS. 11 and 12. The signal of the imager 102 is converted into a digital signal by the analog signal processor 104 and the analog-to-digital converter 105 and then input to the digital signal processor 106. The digital signal processor 106 includes a luminance signal processor 903 and a chrominance signal processor 904. The chrominance signal processor 904 includes a chrominance signal calculator 905, a chrominance signal frame memory 906, an inter-frame chrominance signal subtractor 907, and other processors 908.

Note that the chrominance signal frame memory 906 and the other processors 908 may be mounted on a single semiconductor chip or may be mounted on separate semiconductor chips.

Based on the signal of the imager 102 input to the digital signal processor 106, the luminance signal processor 903 generates a luminance signal (Y signal), and the chrominance signal processor 904 generates a chrominance signal. As the chrominance signal, two color difference signals corresponding to differences between color signals and the luminance signal are typically used: R−Y and B−Y. The chrominance signal processor 904 initially calculates a difference between signals of binned pixels in a diagonal direction as described above. This is performed by the chrominance signal calculator 905 to obtain R−G and B−G as described above. The spectrum of the G signal is similar to that of the luminance signal, and therefore, R−G and B−G may be considered to be a color difference signal. The generated color difference signals are stored in the chrominance signal frame memory 906. Next, the inter-frame chrominance signal subtractor 907 subtracts the color difference signal of the current frame from the color difference signal of the previous frame to obtain a color difference signal from which the influence of a light and dark pattern of an object is removed as described above. Thereafter, the color difference signal is processed by the other processors 908 in a manner similar to that of the conventional art. The other processors 908 perform a gamma process, a matrix process for causing the spectra to approach R−Y and B−Y, etc. The generated luminance signal and color difference signals are transferred to the image compressor/decompressor 107 and the image display 109 as in the above description of the entire configuration.

Note that the color filter pattern and the binning combination are not limited to this embodiment. Various changes and modifications can be made without departing the spirit and scope of the present disclosure.

As described above, an imaging device according to a first aspect of the present disclosure can provide both high-quality moving images and high-definition still images. In particular, conventional image processing can be applied to still images, so that substantially the same image quality as that of the conventional art can be held without need for an additional image process, and moreover, the dynamic range can be enlarged, which is a novel feature. Moreover, color moving images can be provided by adjacent pixel binning, which has an excellent resolution characteristic. As a result, the imaging device can provide more excellent moving images and still images than those of the conventional art, and is considerably useful.

An imaging device according to a second aspect of the present disclosure can effectively reduce or prevent a false signal which is caused by a reduction in color modulation which imposes a serious problem when the imager performs different color pixel binning in order to provide both excellent moving images and still images. The present disclosure overcomes the significant problem with different color pixel binning, whereby a more flexible pixel binning pattern can be employed. As a result, a variety of still images and moving images can be combined, and therefore, the imaging device is considerably useful.

What is claimed is:

1. An imaging device comprising:
an imager configured to convert an optical signal from an object into an electrical signal, the imager including a plurality of photoelectric converters arranged in a horizontal direction and a vertical direction, each photoelectric converter serving as a pixel;
a binning section configured to bin charge of four pixels adjacent to each other in the horizontal and vertical directions of the imager; and
a controller configured to select and control a first operation mode in which signals of all the pixels are separately output without performing the four-pixel binning, and a second operation mode in which signals obtained by the four-pixel binning are output,
wherein
the imager includes a color filter array which provides three or more separate chrominance signals in each of the first and second modes, and
the imaging device further includes a corrector configured to correct the output of the imager so that an RGB Bayer process can be performed in the first operation mode.

2. The imaging device of claim 1, further comprising:
a dynamic range enlarger configured to enlarge a dynamic range by performing correction in the first operation mode.

3. The imaging device of claim 1, wherein
the color filter array is an RGB Bayer array whose transmittance is modulated in a predetermined pattern.

4. The imaging device of claim 1, wherein
the color filter array has two color filter patterns of 2×2 pixels, each including two G color filters, an R color filter, and a B color filter, and in one of the two color filter patterns, the transmittances of the G color filters are higher than the transmittances of the R and B color filters, and in the other color filter pattern, the transmittances of the G color filters are lower than the transmittances of the R and B color filters.

5. The imaging device of claim 3, wherein
the corrector changes the gain of each pixel to cancel the predetermined transmittance modulation pattern of the RGB Bayer array.

6. The imaging device of claim 2, wherein
the dynamic range enlarger, when a pixel having a high transmittance is saturated on the color filter array which is an RGB Bayer array whose transmittance is modulated in a predetermined pattern, performs interpolation using only an unsaturated pixel or pixels before performing the RGB Bayer process.

7. The imaging device of claim 1, wherein
when the four-pixel binning is performed, a combination of two pixels to be binned in the horizontal direction is changed on a post-binning row-by-row basis in units of two rows in which binning is performed in the vertical direction, thereby obtaining separate color signals having three or more colors.

8. An imaging device comprising:
an imager configured to convert an optical signal from an object into an electrical signal, the imager including a plurality of photoelectric converters arranged in a horizontal direction and a vertical direction, each photoelectric converter serving as a pixel, and a color filter configured to pass a specific color being provided for each photoelectric converter to obtain a color image;
a pixel binning section configured to bin charge of the plurality of pixels and output the binned charge; and
a binning combination changer configured to change a combination of pixels to be binned,
wherein
by changing the binning combination, the sign of a difference value between horizontally, vertically, or diagonally adjacent signals after the binning is inverted at the same position.

9. The imaging device of claim 8, wherein
the binning combination changer changes the binning combination on a frame-by-frame basis.

10. The imaging device of claim 8, further comprising:
a chrominance signal calculator configured to calculate a difference between horizontally, vertically, or diagonally adjacent signals after the binning to obtain a chrominance signal;
a chrominance signal frame memory configured to store one frame of outputs of the chrominance signal calculator; and
an inter-frame chrominance signal subtractor configured to subtract one of a chrominance signal of a current input frame and a chrominance signal of a previously stored frame from the other.

11. The imaging device of claim 8, wherein
the combination of a plurality of pixels to be binned includes pixels having two or more color filters.

12. The imaging device of claim 8, wherein
the color filters are RGB primary color filters.

13. The imaging device of claim 8, wherein
the pixel binning is performed on four pixels adjacent to each other in the horizontal and vertical directions.
